(19) United States
(12) Patent Application Publication
(10) Pub. No.: US 2026/0342257 A1
(43) Pub. Date: Oct. 29, 2026

(54) METHOD FOR OPERATING AN ELECTRIC MOTOR, CONTROLLERS FOR AN ELECTRIC MOTOR, ELECTRIC MOTOR DEVICES, AND ELECTRICAL TOOLS

(71) Applicant: Andreas Stihl AG & Co. KG, Waiblingen (DE)

(72) Inventors: Jan Lukas Jackenkroll, Remseck (DE); Johann-Sebastian Renz, Gomaringen (DE)

(73) Assignee: Andreas Stihl AG & Co. KG, Waiblingen (DE)

(21) Appl. No.: 19/397,043

(22) Filed: Nov. 21, 2025

(30) Foreign Application Priority Data
Nov. 29, 2024 (DE) 102024135518.2

(51) Int. Cl. H02P 23/00

(52) U.S. Cl. CPC H02P 23/00

(57) ABSTRACT

The invention is based on a method for operating an electric motor at a specified speed using a controller and a DC voltage source. The controller is designed to control an electrical power consumption of the electric motor during operation at the specified speed. The DC voltage source provides a DC voltage to supply the electric motor with electrical energy. The method comprises the following steps: 1. a voltage value of the DC voltage is detected by the controller and 2. the electrical power consumption is controlled by the controller depending on the voltage value. With the invention, for example, a battery pack can be reliably operated as a DC voltage source even in a cold state and, if necessary, quickly warmed up.

### CROSS-REFERENCE TO RELATED APPLICATIONS

This application claims priority of German Patent Application No. 10 2024 135 518.2, filed Nov. 29, 2024. The disclosure of this prior application is considered part of the disclosure of this application and is hereby incorporated by reference in its entirety.

### FIELD

The disclosure relates to a method for operating an electric motor, controllers for an electric motor, electric motor devices, and electrical tools.

### BACKGROUND

Methods for operating an electric motor, controllers for an electric motor, electric motor devices and electrical tools are known from prior art, for example from the disclosure documents EP 2 505 316 A2 and EP 2 873 490 A1.

### SUMMARY

The disclosure is based on a method for operating an electric motor at a specified speed using a controller and a DC voltage source. The controller is designed to control an electrical power consumption of the electric motor during operation at the specified speed. The DC voltage source provides a DC voltage to supply the electric motor with electrical energy. The method comprises the following steps:
a voltage value of the DC voltage is detected by the controller; and
the electrical power consumption is controlled by the controller depending on the voltage value.

Therefore, the method uses the voltage value of the DC voltage provided by the DC voltage source as a control or input parameter. Further properties, parameters or information, for example, about the DC voltage source, do not need to be collected to carry out the method.

The DC voltage source can, for example, be a DC generator or a battery pack. The battery pack can be both a pack made up of primary cells and a pack made up of secondary cells or a rechargeable battery pack. In particular, it can be rechargeable.

The method can be carried out completely independently of any DC voltage source or battery-pack-specific application or design of the controller of the electric motor or of an electrical tool driven by the electric motor, often with associated limitations for higher-performance DC voltage sources, in particular more powerful or used battery packs. According to the proposed method, the controller sets the electrical power consumed to operate the electric motor or an electrical tool driven by the electric motor depending on the detected voltage value of the DC voltage. The electrical power consumption of the electric motor or an electrical tool driven by the electric motor during operation at the specified speed can thus be adapted by the controller to the DC voltage provided by the DC voltage source or applied to the electric motor or an electrical tool driven by the electric motor.

If the DC voltage source is a battery pack and the battery pack is, for example, in a cold state, and therefore cannot provide the power that it is capable of providing in warm states due to its chemical composition or conditions, for example, this can be registered by the controller using a simple measurement of the DC voltage and the electrical power consumption can be adjusted accordingly. In many cases, such effects occur noticeably below 5° C. In these cold states, the proposed method can be used, for example, to reduce the power of the electric motor or of an electrical tool driven by the electric motor, or a corresponding current, so as not to overload the battery pack and to avoid an excessive voltage drop. The proposed method or the associated function can protect the battery pack not only in cold states, but also in low states of charge or SOC or other unfavorable or states of health or SOH. In such cases, the electrical tool can only be operated with the battery pack in the first place, as otherwise—with an electrical power consumption or power reduction of the tool that is not controlled according to the method—the DC voltage may collapse and/or an undervoltage cut-off of the battery pack and/or the tool may be activated or triggered.

The controller can detect the voltage value on an intermediate circuit, for example. The intermediate circuit can be directly or indirectly linked to the controller so that the controller can detect the voltage value of the DC voltage source using the intermediate circuit. Additionally or alternatively, the voltage value can be detected directly or indirectly by the controller via an electronic input.

The voltage value can be detected by the controller in real time so that the controller can detect the DC voltage that is currently being provided by the DC voltage source and use it to control the electrical power consumption. The voltage value can be detected or measured by the controller and used for further calculations and to control the electrical power consumption. These processes can take place in real time, i.e. within a time interval of 1 ms, for example. However, smaller time periods, for example, 0.1 ms, or larger time periods, for example, 100 ms, are also conceivable. The method can be repeated once or several times. It can be repeated at periodic intervals, for example, at intervals of 0.1 ms, 1 ms, 2 ms, 5 ms, 10 ms, 50 ms or 100 ms. In particular, it can also be carried out or repeated again if a relevant change in the DC voltage is detected by the controller. A relevant change exists, for example, if the change is greater than or equal to 0.1%, 0.2% or 1% of the nominal or rated voltage of the DC voltage source or the detected voltage value. A change can also be detected by the controller as relevant if the change is greater than or equal to 1 mV, 10 mV or 100 mV. This applies in particular to a change that indicates a further drop in the DC voltage. In this case, the method can be repeated to further reduce the electrical power consumption and thus further stabilize the DC voltage. This can be continued until, for example, a constant DC voltage “settles” at a constant operating point on the part of a user of an electrical tool driven by the electric motor. If the DC voltage source is a battery pack and the battery pack is in a cold state, for example, the battery pack can be operated at its power limit by an operator of an electrical tool driven by the electric motor or can be warmed up using the proposed method. If the power of the pack increases again due to warming, the method can be used or repeated to release more power again. This can be repeated until a reduction in the electrical power consumption is no longer necessary, i.e. until the DC voltage or the voltage of the pack has recovered. If there is no voltage drop in a sufficiently powerful battery pack despite its cold state, the method can be designed so that the electrical power consumption is not reduced. If the pack ages, for example, due to intensive use or unfavorable storage, a reduction may be necessary to avoid a voltage drop. The method can be used to react flexibly to such changes. Therefore, the method can be used to recognize and observe the respective condition of a battery pack. Different states (temperature-related states such as warm or cold, SOH and/or SOC) can be automatically taken into account if they are associated with a voltage drop.

The electric motor can be a DC motor with brushes or a brushless DC motor (EC motor). The EC motor can have an external or internal rotor. The specified speed can be the speed of the external or internal rotor of the EC motor or a shaft of the EC motor or the DC motor with brushes. The electric motor therefore converts electrical energy provided by the DC voltage source into rotational movement of a drive element, whereby the drive element can be the external or internal rotor of the EC motor or the shaft of the EC motor or the DC motor, depending on the design of the electric motor.

The controller can be designed as a central module in an electrical tool or an electric motor device with corresponding connections or links in order to carry out the proposed method. However, the controller can also be arranged in an appliance or electric motor device. It can also comprise one or more computing or memory units, measuring modules, and the like.

The method can be used during operation of an electric motor device and/or an electrical tool, which both comprises starting the electric motor device and/or the electrical tool and regular or normal operation.

As part of the proposed method, it is also possible for the controller to regulate the DC voltage to a constant specified minimum DC voltage value using a closed control loop so that the DC voltage does not drop below the constant specified minimum DC voltage value. This can, for example, be implemented using P, D or I control loops or combinations thereof. This can improve the accuracy and reliability of the method.

The controller can also be designed to limit the electrical power consumption using a specified maximum value of a maximum power consumption. By limiting using a specified maximum value, a maximum electrical power consumption can be maintained by the controller to reduce or avoid overloads, overcurrents or heat generation during operation of the electric motor.

The specified maximum value can be reduced by the controller if the voltage value falls below a specified voltage level. This allows the electrical power consumption of a cold battery pack, for example, to be optimized in such a way that the battery pack is operated as close as possible to its power limit and thus warmed up as quickly as possible. The battery pack can thus be brought to a warm state more quickly than would be possible, for example, with a conservatively designed limitation or a general reduction in electrical power consumption, for example, by 50%. Such conservative limitations or general reductions are often designed for the worst possible application case. In comparison, the proposed method allows more powerful DC voltage sources, in particular battery packs, to be utilized more reliably or better.

The specified maximum value can be reduced by the controller by determining the specified maximum value by multiplying a specified normal value by a factor by the controller. The specified normal value and the specified maximum value coincide or have the same value if the voltage value is the same as the specified voltage level or is above the specified voltage level. The factor or reduction factor can fall monotonically with the deviation of the voltage value from the specified voltage level and/or be determined by the controller using a characteristic curve, whereby the characteristic curve is suitable for assigning a precise value for the factor to the deviation of the voltage value from the specified voltage level. In particular, the factor can have a value that is greater than or equal to 0 and less than or equal to 1, with 0 corresponding to no power consumption and 1 corresponding to no limitation of the power consumption. The factor can be reduced at least partially using a linear relationship if the voltage value falls below a specified voltage level. The factor can also be reduced along other monotonically decreasing functions, for example, along a correspondingly designed hyperbolic tangent. Such functional relationships are not only easy to implement or realize. They also enable reliable statements or assessments to be made about the behavior of the electrical tool.

The specified maximum value can be kept above a specified maximum value level by the controller. The specified maximum value level can, for example, be 50%, 30% or 20% of the specified normal value. This can be achieved by the controller, for example, by keeping the above-described factor or reduction factor above a value that corresponds to the specified maximum value level. If the maximum value level is, for example, 30% of the specified normal value, the factor can be kept above a value of 0.3. In this way, it can be ensured that the specified maximum value is greater than or equal to a specified minimum value.

The controller can detect a status parameter of the DC voltage source and control the electrical power consumption depending on the status parameter. In this way, the controller can also adapt the electrical power consumption, for example, to different states of the DC voltage source, in particular battery pack states resulting from age or use (SOH), temperature (warm, cold), state of charge (SOC), etc. The status parameter can be detected by the controller or corresponding sensors, such as temperature sensors in the DC voltage source or an electrical tool operated with the electric motor, using a signal or communication line. The status parameter can also be detected by the controller in real time.

The voltage value of the DC voltage source can be detected by the controller as the result of a filtering process. The DC voltages applied to the above-mentioned intermediate circuit or electronic input, for example, can be measured. The measured values can then be filtered by a low-pass filter, for example. The measured values can also be temporarily stored by the controller and/or averaged over time in order to record the voltage value. This means that not every change in the DC voltage has a direct effect on the control of the electrical power consumption. The operation of an electric motor device operated with the electric motor or an electrical tool operated with the electric motor at the specified speed can be made more reliable and in many cases also more pleasant for an operator of the electric motor device or the electrical tool by such filtering or damping processes.

Furthermore, the disclosure is based on a method for operating an electric motor using a controller and a DC voltage source. The controller is designed to control an electrical power consumption of the electric motor. The DC voltage source provides a DC voltage to supply the electric motor with electrical energy. The method comprises the following steps, among others:

a specified speed for the electric motor is detected by the controller; and the power consumption of the electric motor is controlled by the controller according to a method for operating the electric motor at the specified speed as described above.

The electrical power consumption of the electric motor can therefore be controlled in a cascaded manner, whereby a speed is initially specified and the electrical power consumption at the specified speed is additionally adapted to the voltage value of the DC voltage detected by the controller.

The speed can, for example, be specified at least indirectly by an operator of an electric motor device operated with the electric motor or of an electrical tool operated with the electric motor via a throttle lever.

A further starting point of the disclosure is a controller for an electric motor which is designed to carry out the method steps of one of the methods just described using a DC voltage source which provides a DC voltage to supply the electric motor with electrical energy.

An electric motor device with a controller and an electric motor is a further starting point of the disclosure, wherein the controller is designed to carry out the method steps of one of the methods just described using a DC voltage source which provides a DC voltage to supply the electric motor with electrical energy.

An electrical tool with a controller or electric motor device as just described is also a starting point of the disclosure. A further starting point of the disclosure is a computer program comprising instructions which cause a controller, an electric motor device or an electrical tool as just described to carry out the method steps of one of the methods just described. This also applies to a computer-readable medium on which the computer program just described is stored.

### BRIEF DESCRIPTION OF THE DRAWINGS

Further features and aspects of the disclosure are shown in the following figures, in which examples of the disclosure are shown in detail. The examples shown are illustrative. It is understood that there are a number of other different ways of carrying out the disclosure. Here:

FIG. 1 shows a schematic representation of an example of an electrical tool according to the disclosure with a battery pack,

FIG. 2 shows a flow chart of an example of a method according to the disclosure, and

FIG. 3 shows a characteristic curve.

### DETAILED DESCRIPTION

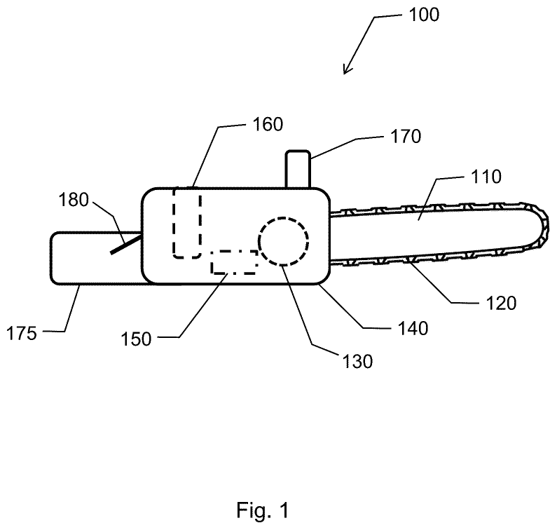

FIG. 1 shows a hand-held electrical tool 100. The electrical tool 100 is designed as a motor or chain saw with a rail 110. However, the disclosure is not limited to motor or chain saws, but can also be used for cut-off grinders, brush cutters, and other electrical tools. A saw chain 120 runs around the rail 110 during operation of the chainsaw. The saw chain 120 is driven by an electric motor 130. The electric motor 130 is located in a housing 140. In addition to the electric motor 130, a controller 150 is accommodated in the housing 140. The controller 150 is connected to the electric motor 130 to control it. The controller 150 is connected to a shaft 160 via electrical lines. A battery pack can be inserted into the shaft 160 to supply the electric motor 130, the controller 150, and the electrical tool 100 with electrical energy. The battery pack can be changed if necessary, for example, to recharge it or replace it with another battery pack. If the battery pack is inserted in the shaft 160, it provides a battery voltage for supplying the controller 150 and the electric motor 130 with electrical energy. The battery voltage is then applied to the controller 150 via a corresponding interface and can therefore be determined or detected by the controller via a voltage measurement. The battery voltage is a DC voltage and has a voltage value. The voltage value is determined or detected by the controller 150 via the voltage measurement. The battery pack is also equipped with a communication interface for forwarding a temperature signal to the controller 150. The electrical tool is designed for operation with battery packs that can be reliably operated when the battery voltage is above 27V. Other examples of tools according to the disclosure can be designed for operation with battery packs that can be reliably operated when the battery voltage is above 5V, 10V, 15V, 20V or 50V.

The housing 140 further has an upper handle 170 and a rear handle 175. By means of the upper handle 170 and the rear handle 175, the electrical tool 100 can be operated by an operator with two hands. A throttle lever 180 is located near the rear handle 175. The operator can use the throttle lever 180 to transmit a throttle lever signal to the controller 150, which is converted into a specified speed by the controller 150. For this purpose, the controller 150 translates the throttle lever signal into the specified speed using a speed table which is stored in a memory which can be accessed by the controller 150. The electric motor 130 can then be operated by the controller 150 at the specified speed and with the electrical energy from the battery pack.

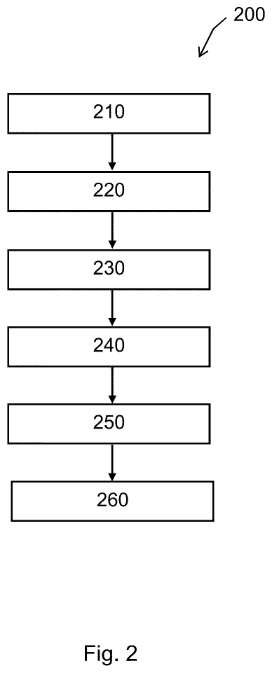

FIG. 2 shows a method 200 according to the disclosure. The method 200 is carried out by the controller 150 to operate the electric motor 130 of the electrical tool 100. After inserting a battery pack into the shaft 160, the method 200 begins with step 210, in which an actuation of the throttle lever 180 is registered by the controller 150 and a throttle lever signal corresponding to the actuation is converted into a specified speed. The controller 150 uses the above-described speed table stored in the memory to convert the throttle lever signal corresponding to the actuation into the specified speed. At the next step 220, the battery voltage is measured or detected by the controller 150. The controller records a measured value of the battery voltage applied to the controller 150 via the electronic input. Next, at step 230, the controller 150 records the temperature signal, which is provided by the battery pack via the communication interface of the controller 150. At step 240, the controller 150 then uses the temperature signal to determine a specified normal value. The specified normal value is determined-similarly to the specified speed using the speed table-using a normal value table stored in the memory described above. With the normal value table, the controller 150 can uniquely determine the normal value using the specified speed and the temperature signal. At the next step, step 250, a factor is determined by the controller 150 using a characteristic curve with the voltage value recorded at step 220. The factor determined with the characteristic curve is then multiplied by the controller 150 with the normal value in order to form a specified maximum value of a maximum power consumption. At step 260, the controller 150 now controls the electrical power consumption of the electric motor 130 to operate it at the specified speed detected by the controller at step 210. In doing so, the electrical power consumption is limited by the controller 150 by the specified minimum value and the specified maximum value.

The electrical power consumption of the electric motor 130 is therefore adapted by the controller to the battery voltage applied to the controller 150 and the temperature signal of the battery pack. In this way, the electrical power consumption of the electrical tool 100 can be reduced by the controller so as not to overload the battery pack and to avoid an excessive voltage drop in one or more cells of the pack. The operator can even operate the battery pack up to its power limit by actuating the throttle lever in order to preheat the pack optimally, without the risk of the battery voltage collapsing and/or an undervoltage cut-off of the battery pack and/or the electrical tool being activated or triggered.

The method 200 can be repeated. If the reduction by executing the method is not sufficient, a further voltage value can be detected with a repeated execution of the method and the reduction factor can be redetermined. In many cases, the method can be repeated until a constant voltage settles. In this way, the battery pack can be operated at its performance limit.

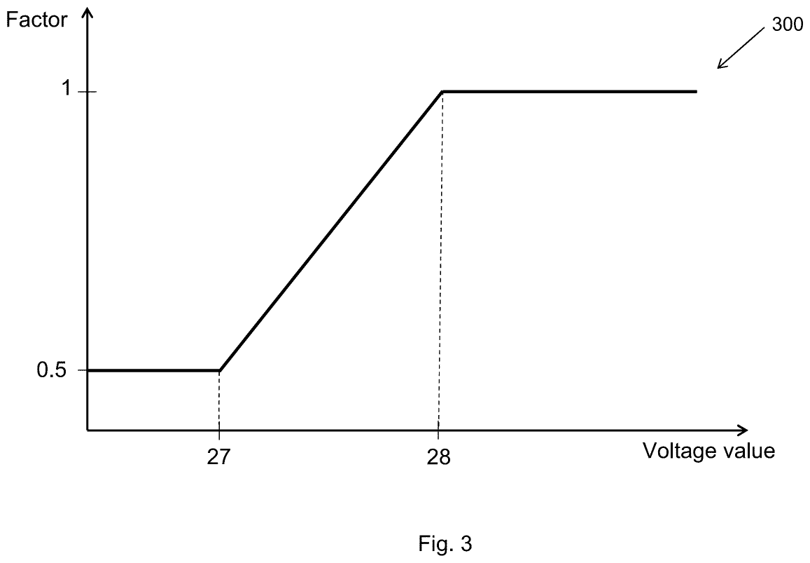

FIG. 3 shows a characteristic curve 300. The characteristic curve 300 is used by the controller 150 at step 250 to determine the factor by which the specified normal value is multiplied by the voltage value recorded at step 220. The voltage value indicates the value of the DC voltage in the SI unit volt. The factor is assigned the value 1 by the controller if the voltage value is greater than or equal to 28, i.e. the DC voltage is greater than or equal to 28V. The controller assigns the value 0.5 to the factor if the voltage value is less than 27, i.e. the DC voltage is less than 27V. If the voltage value is less than 28 but greater than or equal to 27, the factor is determined by the controller using the following formula:

Factor=(voltage value−26)/2.

Many other characteristic curves are also conceivable.

1. A method for operating an electric motor at a specified speed;
using a controller and a DC voltage source;
wherein the controller is designed to control an electrical power consumption of the electric motor during operation at the specified speed;
wherein the DC voltage source provides a DC voltage to supply the electric motor with electrical energy;
with the following steps:
a voltage value of the DC voltage is detected by the controller and
the electrical power consumption is controlled by the controller depending on the voltage value.

2. The method according to claim 1, characterized in that:
the controller is designed to limit the electrical power consumption using a specified maximum value of a maximum power consumption; and
the specified maximum value is reduced by the controller if the voltage value falls below a specified voltage level.

3. The method according to claim 2, characterized in that:
the specified maximum value can be reduced by the controller by determining the specified maximum value by multiplying a specified normal value by a factor by the controller;
wherein the specified normal value and the specified maximum value coincide if the voltage value is equal to the specified voltage level or is above the specified voltage level; and
the factor decreases at least partially monotonically with the deviation of the voltage value from the specified voltage level; and/or
the factor is determined by the controller on the basis of a characteristic curve, the characteristic curve being suitable for precisely assigning a value for the factor to the deviation of the voltage value from the specified voltage level.

4. The method according to claim 2, characterized in that the specified maximum value is kept by the controller above a specified maximum value level.

5. The method according to claim 1, characterized in that the controller can detect a status parameter of the DC voltage source and control the electrical power consumption depending on the status parameter.

6. The method according to claim 1, characterized in that the voltage value of the DC voltage is detected by the controller as a result of a filtering process.

7. A method for operating an electric motor comprising:
using a controller and a DC voltage source;
wherein the controller is designed to control an electrical power consumption of the electric motor;
wherein the DC voltage source provides a DC voltage to supply the electric motor with electrical energy;
with the following steps:
a specified speed for the electric motor is detected by the controller and
the power consumption of the electric motor is controlled by the controller according to a method according to claim 1.

8. A controller for an electric motor;
wherein the controller is configured to perform the method steps of a method according to claim 1, using a DC voltage source which provides a DC voltage for supplying the electric motor with electrical energy.

9. An electric motor device with a controller according to claim 8 and an electric motor.

10. An electrical tool with a controller according to claim 8.
